(19) United States
(12) Patent Application Publication
(10) Pub. No.: US 2016/0134228 A1
(43) Pub. Date: May 12, 2016

(54) A PHOTOVOTAIC ARRAY WITH FLOATING RAFT FOUNDATIONS

(71) Applicant: Tao SUN, Jiangsu (CN)

(72) Inventor: Tao Sun, Suzhou (CN)

(21) Appl. No.: 14/897,024

(22) PCT Filed: Jun. 3, 2014
(86) PCT No.: PCT/CN2014/079055

§ 371 Date: Dec. 9, 2015

(30) Foreign Application Priority Data
Jun. 11, 2013 (CN) 201310231929.0

(51) Int. Cl. H02S 20/10

(52) U.S. Cl. CPC H02S 20/10

(57) ABSTRACT

A photovoltaic array with floating raft foundations comprising at least three photovoltaic integrated boards; the area of the photovoltaic array larger than 10 square meters; at least two photovoltaic integrated boards in contact with the ground. Length of at least three photovoltaic integrated boards is greater than three meters. The photovoltaic array with floating rafts foundations is a whole system, which can significantly reduce the use of the traditional foundation, save construction time, and reduce system cost.

### BACKGROUND OF THE INVENTION

1. Technical Field

The present invention relates to a solar photovoltaic power generation system. More particularly, this invention relates to a photovoltaic array using photovoltaic modules integrated boards.

2. Description of Related Art

Solar energy are clean, inexhaustible. Most renewable energy such as wind, hydropower, biomass is transformed from solar indirectly. The current dominant fossil fuels such as coal, oil, natural gas also comes from ancient biomass. So solar energy is the most important and most promising renewable energy.

However, the current solar energy people used is less than 1% of the total energy. The main reason is the high cost of solar energy. It can not compete with cheaper conventional fossil energy.

Now the vast majority of current photovoltaic industry have invested too much time and money to improve solar battery efficiency itself, that's not a good idea. Of course, the higher labor costs in the region, the higher efficiency can reduce system installation costs, there is a certain positive significance. But many new rapid mounting device also can significantly reduce system installation costs.

The photovoltaic power plant structure with fixed angle hasn't changed for decades since the invention of the solar cell.

The cost of solar photovoltaic power plant typically includes the following components cost, photovoltaic module cost, bracket cost, foundation costs, labor cost, the cost of the inverter and so on. The total costs except photovoltaic modules is also known as BOS (balance of system) cost.

From the natural law of development of the energy industry, the scale is a common and effective means of reducing costs. In all other power station including wind power, thermal power, nuclear power, hydropower, the nature law is the same. Therefore, the nature law will be the same in photovoltaic power station. The bigger the scale of the power station, the lower the average cost-sharing on a number with fixed costs. According to reports, the average cost of the installed photovoltaic system of less than 2 kW in USA in 2011 is about $ 7.7 per watt, the average cost of the large-scale commercial photovoltaic system of more than 1,000 kilowatts is $ 4.5 per watt and the average cost of the photovoltaic system of more than 10,000 kilowatts is around $3 per watt.

The cost of photovoltaic modules in small or large photovoltaic system is almost the same. So the BOS cost is much higher than the cost of photovoltaic modules. It's well known that photovoltaic modules are made of more sophisticated and expensive components, such as silicon wafer and so on. The support structure is made of cheap steel and cement. So reducing other installation costs become a highest priority.

Currently there are several ways the reduce the installation time:

Firstly, robots were used to install photovoltaic module. But the photovoltaic module is easy to break and it has a flexible cable. So it's difficult for robot to handle.

Secondly, a temporary assembly line can be set up near the photovoltaic power plants. It will assemble photovoltaic components and supporting structure together in the field. However, most photovoltaic power plant has very poor geological and weather conditions, or lack of electricity and engineer. There are some difficulties in temporary assembly lines.

And finally, it's the photovoltaic modules integrated board. the related technologies are still in concept stage.

### SUMMARY OF THE INVENTION

It is difficult to install the foundations of photovoltaic power plants. Usually there are in-line pile foundation, screw pile forms, strip concrete foundation and massive concrete foundations and so on. After the concrete pouring, within a certain time required proper external temperature and humidity. It will take days or even dozens of days for conservation to a certain intensity.

For the shortcomings existed in the current techniques, this invention provides a photovoltaic array with floating raft foundations.

Here, the PV modules integrated board refers to a certain size board with several PV modules and the support structure which easy to install and transport. The area of all PV modules is larger than three square meters. To facilitate the use of container transport, its shape should be elongated plate. Specifically, the ratio of PV modules integrated board length and width should be greater than 1.5. Obviously integrated photovoltaic modules should be located on the front panel to fully absorb sunlight. In order to avoid mutual blocking between assembly of PV modules that should be located on a smooth plane. The backboard of the PV modules integrated board includes sandwich boards, pressed metal plates, steel framework and other forms.

Is the foundation necessary for a PV power plant? Obviously not. Ancient Chinese architecture generally consists of pedestal, beams, roof structure. Some pedestal of ancient Chinese architecture is a whole raft floating base, can effectively deal with all kinds of wind and snow, earthquakes and so on. In fact, the concrete strip foundation of photovoltaic power plants is also similar to floating raft. But considering the concrete characteristics and the influence of traditional structures, it can not be quickly installed.

If horizontal PV modules on the ground is heavy enough, the wind can not blow it up. Of course, if it rains snow, rain and snow will cover assembly, leakage may cause corrosion and other damage. Therefore, it should maintain a certain distance from the ground.

Considering the above factors, the present invention is that a photovoltaic array, characterized in that it comprises at least three photovoltaic modules integrated boards; The area of photovoltaic array greater than 10 square meters; at least two photovoltaic modules integrated boards in contact with the ground as floating raft foundation.

A photovoltaic array with floating raft foundations comprising at least three PV integrated boards, in order to play the scale. If PV integrated boards is too small, it is even worse than a large PV module. And to install a single photovoltaic module integrated board is equivalent to simultaneously install multiple photovoltaic modules. So the bigger, the better.

Preferably, the distance between the photovoltaic module of photovoltaic modules integrated boards and the ground is greater than 8 cm. If PV modules is too close to the ground, it may be easily damaged by snow, rain and sand.

Preferably, it comprises at least three photovoltaic modules integrated boards which length are greater than 3 m.

Preferably, the raft plate is fixed on the photovoltaic modules integrated boards.

The photovoltaic modules integrated boards should be in direct contact with the ground for direct and reliable support. In order to prevent further moisture corrosion or sharp gravel, a raft plate should be fixed at the bottom of photovoltaic modules integrated boards. In addition to the buffer pad uneven ground itself, but also slightly elevated integrated board, avoid ground water corrosion. Meanwhile a special raft plate makes the other parts of the PV modules integrated boards greatly reduce the chance of contact with the ground. The other parts does not require thick anti-corrosion coating. This also reduces a lot of cost.

Preferably, the PV modules integrated board is stackable. Stackable PV modules integrated boards can greatly reduce the volume occupied during transport, reducing transport costs.

Preferably, the angle between the raft plate and the light-receiving surface of the photovoltaic module is more than 120 degrees. The raft plate is substantially parallel to the ground. Considering the angle between the PV module of the vast majority of power plants and the ground is less than 60 degrees. It is preferably greater than 120 degrees.

Preferably, the material of the back board of PV modules integrated boards is pressed metal plate. Metal plate is easy to shape.

Preferably, the material of the back board of PV modules integrated boards is steel plate. The steel plate with a sufficiently thick coating and paint is cheap and preservative.

Preferably, the PV modules integrated board should be arranged around the adjacent long side fixed to each other. Before and after such a long length, and height unchanged, the overall shape is more low. Because of the integration between the plates are secured together, even as a whole. It's more stronger than a single integrated board.

Preferably, the photovoltaic modules integrated boards are fixed with screws.

Preferably, each component of photovoltaic modules integrated board is pre-wired. Pre-wired components can reduce installation time.

The advantageous effects of the present invention are:

1, due to the photovoltaic module integrated board itself straight contact with the ground, reducing the intermediate links, thereby greatly improving installation speed, material cost savings. In some cases the foundation may be omitted entirely. This is difficult to do other techniques.

2, a higher speed of installation not only helps to reduce installation costs, geographical and climatic conditions can also reduce the adverse impact on construction.

3, installation and removal time is shortened significantly to reduce labor costs. Removing shorten the recovery time is also conducive to reuse components.

4, due to the easy accessibility can be used for temporary venues, some cases can replace diesel generators.

5, little effect on the ground, and is reversible. After the demolition of the ground restitution. It can be used for fallow land and other special venues, greatly expanded its scope of application. It can also greatly simplify the approval procedures.

In short, rapid deployment capability to install photovoltaic array can not only reduce costs, but also greatly expanded its use. Considering the large-scale development of solar energy industry in the future, its economic and social benefits are very high.

### BRIEF DESCRIPTION OF THE DRAWINGS

FIG. 1 is a three-dimensional view of an embodiment of the invention.

FIG. 2 is a front view of an embodiment of the invention.

FIG. 3 is a plan view of an embodiment of the invention.

FIG. 4 is a side view of an embodiment of the invention.

FIG. 5 is a partial side view of an embodiment of the invention.

FIG. 6 is a side view of stackable photovoltaic modules integrated boards.

### EMBODIMENT OF THE INVENTION

Implementation, features and advantages of the present invention was further described with reference to the embodiments.

It should be understood that the specific embodiments described herein are merely for explaining the present invention and are not intended to limit the present invention.

A specific embodiment of the floating raft photovoltaic array comprising at least three integrated PV panels; PV array area greater than 10 square meters, at least two PV modules integrated boards in contact with the ground.

The present invention also fixed a plate underneath PV modules integrated board.

The present invention is further characterized by PV modules integrated board is stackable.

The present invention is further characterized by the angle between the plate and the light-receiving surface of photovoltaic modules is greater than 120 degrees.

The present invention also includes at least three PV modules integrated boards which length is greater than 3 meters.

The present invention is further characterized in that the material used for the steel plate.

The present invention is further characterized in that the support plate of PV modules integrated board is pressed metal plate.

The present invention is further characterized by PV modules integrated board should be arranged around the adjacent long side fixed to each other.

The present invention is further characterized by the use of screw connection between PV modules integrated board. Screw connection for easy removal and maintenance

The present invention is further characterized in that each assembly of PV modules integrated board in advance on-line.

The present invention is also that the lower plate PV modules integrated PV modules along with greater than 8 cm from the ground.

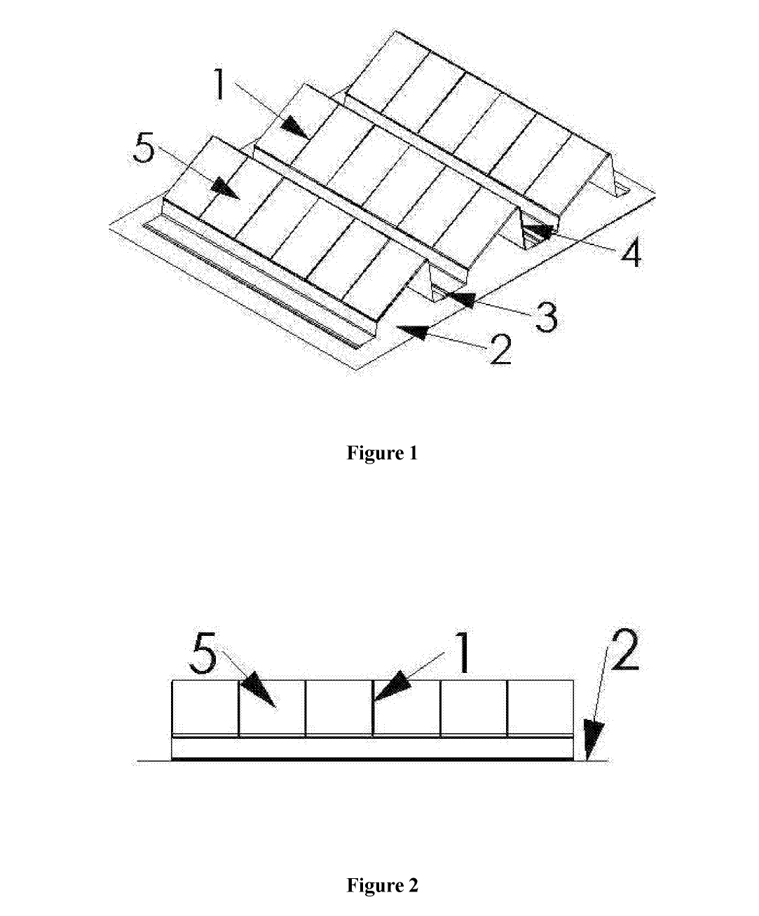

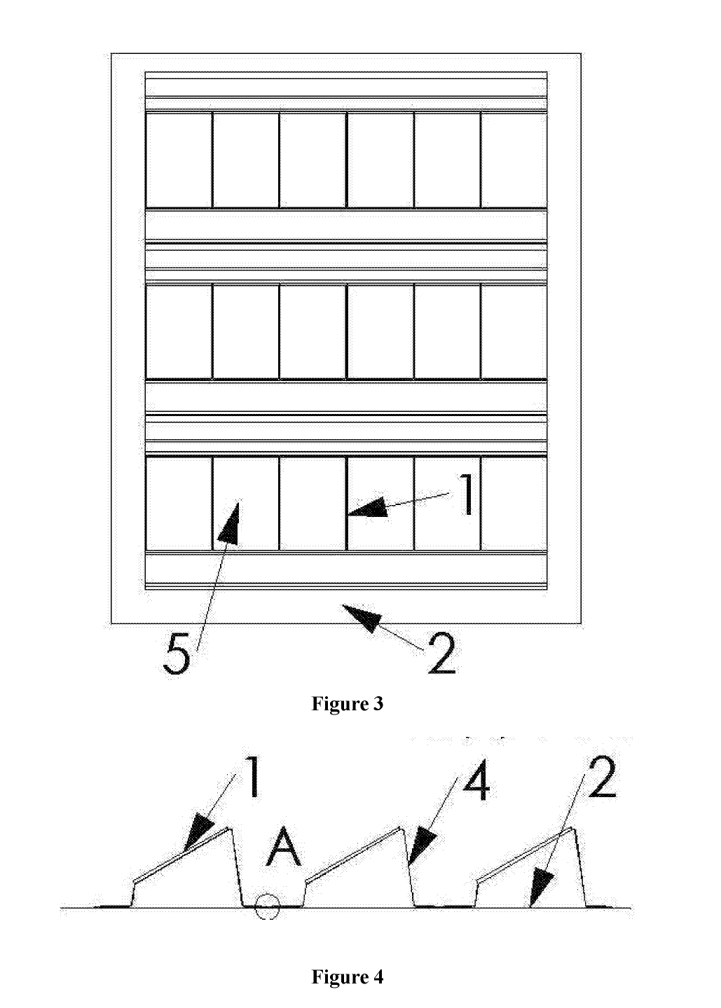

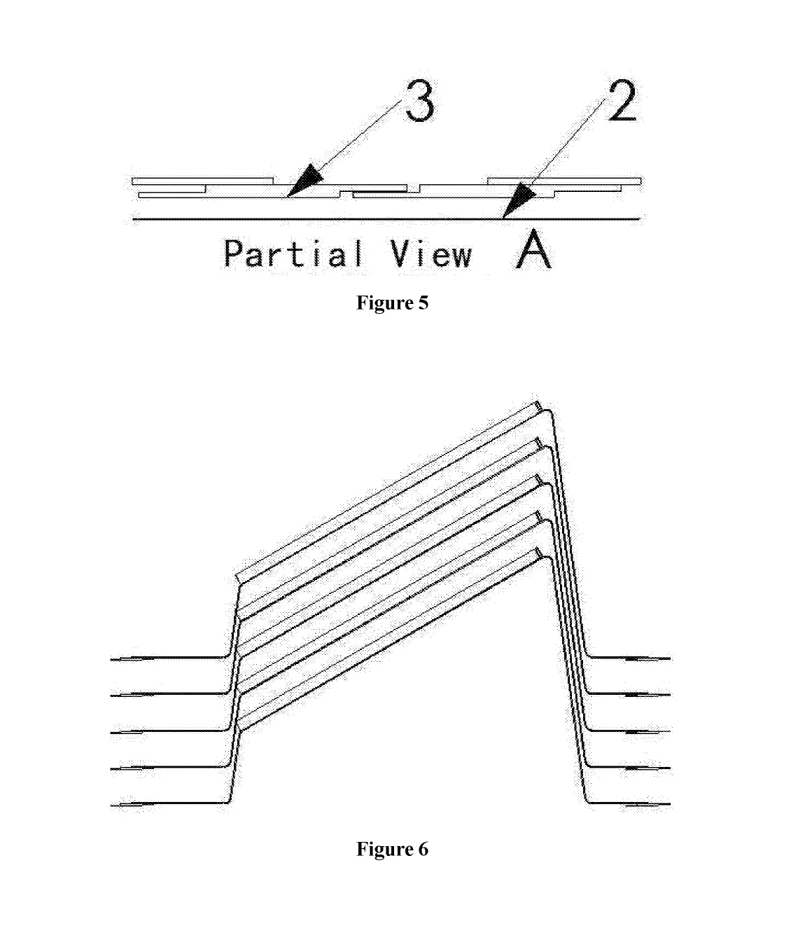

FIG. 1 is a three-dimensional view of an embodiment of the invention. FIG. 2 is a front view of an embodiment of the invention. FIG. 3 is a plan view of an embodiment of the invention. FIG. 4 is a side view of an embodiment of the invention. FIG. 5 is a partial side view of an embodiment of the invention. FIG. 6 is a side view of stackable photovoltaic modules integrated boards.

As shown in FIG. 1, 2, 3, 4, three PV modules integrated boards 1 adjacent to each other long side fixed together to put on the ground 2 to form a PV array. PV modules integrated board 1 comprises PV modules 5, back plate 4, raft plate 3 and other components.

As can be seen from FIG. 5, the two raft plate 3 of neighboring PV integrated board 1 is fixed to each other. Due to its low profile, the PV array may not need the traditional foundation. Several PV modules integrated boards is fixed together as a whole plate floating on the ground. Obviously, if the wind is too strong, we still need some foundation. But compared with the traditional power plants, the number of foundations will be much less. PV modules require a certain tilt angle. The angle was set by pressed metal plate. Therefore it is fixed angle, and almost not adjustable. The tilt angle can be change by selecting different types or different combinations of back plate.

As can be seen from FIG. 6, the photovoltaic modules integration board 1 can be stacked, to save the volume and reduce the floor, which is more suitable for long-distance transport and reducing transport costs.

Furthermore, the foregoing descriptions of the embodiments according to the present invention are provided for illustration only, and not for the purpose of limiting the invention as defined by the appended claims and their equivalents.

The invention claimed is:

1. A photovoltaic array, characterized in that it comprises at least three photovoltaic modules integrated boards; the area of photovoltaic array greater than 10 square meters; at least two photovoltaic modules integrated boards in contact with the ground as floating raft foundation.

2. The photovoltaic array according to claim 1, characterized in that it comprises at least three photovoltaic modules integrated boards which length are greater than 3 m.

3. The photovoltaic array according to claim 1, characterized in that the distance between the photovoltaic module of photovoltaic modules integrated boards and the ground is greater than 8 cm.

4. The photovoltaic array according to claim 1, characterized in that the photovoltaic modules integrated boards are connected to the front and rear.

5. The photovoltaic array according to claim 1, characterized in that the raft plate is fixed on the photovoltaic modules integrated boards.

6. The photovoltaic array according to claim 1, characterized in that the photovoltaic modules integrated board is stackable.

7. The photovoltaic array according to claim 1, characterized in that the angle between the raft plate and the photovoltaic module of the photovoltaic modules integrated board is more than 120 degrees.

8. The photovoltaic array according to claim 1, characterized in that the photovoltaic modules integrated board support plate is pressed metal plate.

9. The photovoltaic array according to claim 1, characterized in that the photovoltaic modules integrated boards are fixed with screws.

10. The photovoltaic array according to claim 1, characterized in that each component of photovoltaic modules integrated board is pre-wired.
